(19) United States
(12) Patent Application Publication
(10) Pub. No.: US 2020/0406313 A1
(43) Pub. Date: Dec. 31, 2020

(54) Systems and Methods for Improving Throughput, Precision, and Accuracy in Electronic Trace Detectors

(71) Applicant: Rapiscan Systems, Inc., Torrance, CA (US)

(72) Inventors: Bradley Douglas Shaw, Plaistow, NH (US); William Rogers, Somerville, MA (US); Vladimir Romanov, Pelham, NH (US); Adam Justin Maines, Steamboat Springs, CO (US); Brittney Hoehing, Jamaica Plain, MA (US); Gennadiy N. Berezutskiy, Tewksbury, MA (US); Kurt R. Bistany, Methuen, MA (US)

(21) Appl. No.: 16/452,545

(22) Filed: Jun. 26, 2019

(51) Int. Cl. B08B 5/02; G01N 27/62; H01J 49/02; G01N 30/40

(52) U.S. Cl. CPC B08B 5/02; G01N 27/624; G01N 2030/402; G01N 30/40; H01J 49/02

(57) ABSTRACT

Embodiments of the present specification provide methods and systems for clearing a detector of contaminants or any other undesirable substances that may affect operation of detector. The methods and systems enable a clear-down mode to clear the detector after an alarm is detected during sampling by the detector. The clear-down mode may be enabled immediately upon detecting a substance of interest. Further, the clear-down mode is effective to increase and direct all air flow through the detector in order to maximally purge contaminants from the detector.

### CROSS REFERENCE

The present specification relates to U.S. patent application Ser. No. 15/388,589 entitled “Systems and Methods for Calibration, Verification, and Sensitivity Checks for Detectors”, filed on Dec. 22, 2016, and is hereby incorporated by reference in its entirety.

The present specification relates to U.S. patent application Ser. No. 15/379,834 entitled “Methods and Devices for Moisture-Based Calibration”, filed on Dec. 15, 2016, and is hereby incorporated by reference in its entirety.

The present specification also relates to U.S. Pat. No. 9,766,218 entitled “Gas Curtain at Inlet for Trace Detector” issued on Sep. 19, 2017, and is hereby incorporated by reference in its entirety.

### FIELD

The present specification relates to improving the precision and accuracy of Electronic Trace Detectors (ETD) operation. More particularly, the present specification relates to reducing an amount of time needed to clear an alarm in the ETD, by use of an automatic clear-down protocol.

### BACKGROUND

Electronic Trace Detectors (ETDs) utilize certain procedures to prepare the detectors for use after each detection alarm, time period, or predefined number of uses. The procedures include a cleaning protocol designed to clear the flow path in preparation for the next sample. For example, following an alarm, the electronic trace detector (ETD) typically undergoes a cleaning protocol. Flows are redirected to purge contaminants collected during use. The time required to execute the cleaning protocol is termed as the “clear-down time”. The cleaning protocol is necessary to confirm that a consistent baseline is set after an alarm, predefined period of time, or predefined number of uses, and prior to receiving the next sample. The baseline is defined as when the ETD is not displaying any additional peaks or signals other than a dopant background. A consistent baseline is necessary to ensure a precise and accurate operation of the ETD, otherwise, contaminants may carry over through several sample cycles.

Most ETDs use a standard clear-down time that may range from one to five minutes. In some cases, where high loads are involved, the clear-down time require several hours. A high load alarm is defined as a signal from a substance of interest significantly higher than the alarm threshold. During the clear-down time, the ETD is unavailable for operation, thus it is desirable to reduce the clear down time. Reducing the clear-down time allows the operator to maximize sample throughput during use. An increased amount of sample in the ETD, in turn, increases the length of the clear-down time. In some methods, a user could sample repeatedly for clear-down until all the substance of interest is pulled through the exhaust of the ETD. This will also likely result in a longer clear-down time and is less desirable. In some cases, the clear-down time can be shortened by rapidly ramping up the temperature of the system to 500-600° C., by rapidly switching between positive and negative modes of operation, or by combining a detector unit with a filtering sub-unit including a pump and a filter.

U.S. Patent Application No. 20130298938, assigned to Smiths Detection Montreal Inc., discloses “[a] method comprising: receiving a clear-down trigger; and fast clearing-down an ion mobility spectrometer, responsive to receipt of the clear-down trigger, to remove residual sample accumulated during previous analysis of a sample, wherein clearing-down is performed by fast-switching between positive and negative modes to purge the residual sample from the ion mobility spectrometer”.

U.S. Pat. No. 5,554,846, assigned to Environmental Technologies Group, Inc., discloses an apparatus for detecting alarm molecules, whereby “residual alarm molecules are automatically removed during a clear-down mode before a subsequent air sample is to be introduced. The apparatus comprises a detector unit, a sensor unit and a filtering sub-unit including a pump and a filter. During a challenge, the pump in the sub-unit is turned off, and the air sample passes from the inlet port of the first unit through the second unit to the output port of the first unit, thereby depositing alarm molecules in the first unit and the second unit. During the clear-down mode, the pump in the sub-unit is turned on, and outside air enters through the output port of the first unit, mixes with air flow from the output of the second unit, and passes through the sub-unit. Filtered air from the sub-unit exhausts the first unit through the inlet port of the first unit and passes into the second unit, thereby cleaning the first unit and the second unit from the alarm molecules deposited therein during the challenge mode.”

In addition, conventional ETDs are known to use curtain and drift flow for performing the cleaning protocol. Some ETDs do not stabilize pressure before attempting an air sample, likely resulting in an inaccurate time of flight reading which will not clean properly or consistently. This results in an inconsistent baseline, thus reducing the accuracy and precision of the ETD. In addition, some conventional ETDs do not stabilize the internal pressure by pulsing the sample pump before attempting an air sample. While the pressure eventually stabilizes on its own, this typically takes an extra period of time. Reducing the time required for clearing will allow an operator to maximize sample throughput during operation. In some cases, the time required for clearing is less than one minute. Thus, there is a need for systems and methods that reduce the amount of time needed to clear an alarm, thereby increasing throughput of the overall system.

### SUMMARY

The following embodiments and aspects thereof are described and illustrated in conjunction with systems, tools and methods, which are meant to be exemplary and illustrative, not limiting in scope.

The present specification discloses a method for clearing a trace detector of one or more substances, wherein the trace detector comprises a desorber in flow communication with a detector and wherein the detector comprises a detector input, a first port, and a second port, the method comprising: operating a detector pump, wherein the detector pump is configured to direct air flow through a first valve to an inlet of the desorber and direct air flow through the first port to the detector; operating a sample pump, wherein the sample pump is configured to direct air flow from the second port of the detector; using the desorber, vaporizing the one or more substances; using the detector, initiating a detection process for a first predefined time period in order to detect a presence of the one or more substances; in response to detecting the presence of the one or more substances, generating an alarm indicating the presence of at least one contaminant or interferant; in response to detecting the presence of the one or more substances, automatically terminating detection before the first predefined period of time has elapsed; after terminating detection, clearing the detector, wherein clearing the detector comprises, for a second predefined period of time: stopping air flow out of the second port of the detector; closing the first valve to stop air flow from the detector pump to the inlet of the desorber; and increasing air flow from the detector pump to the first port to the detector.

Optionally, the method further comprises causing an amount of the contaminants or the interferants in the trace detector to become less than a configurable amount, wherein the configurable amount ranges from 60 to 80% of a detectable signal intensity required to generate an alarm. Optionally, the method further comprises, after the second predefined period of time, opening the first valve and re-directing air flow through the first valve to the inlet of the desorber, thereby re-initiating air flow out of the second port of the detector. Optionally, the detector pump is driven at a maximum voltage corresponding to a maximum flow rate and pressure of the detector.

Optionally, the contaminants comprise one or more of TNT, RDX, Tetryl, nitrates, PETN, HMTD, lactic acid, interferences, or narcotics. Optionally, the detector is at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a traveling wave ion mobility spectrometer, a mass spectrometer (MS), or a gas chromatograph (GC). Optionally, the interferents comprise at least one of a health product, a beauty product, food, drink, dirt, dust, oil, or grease.

Optionally, the method further comprises, using the sample pump, generating one or a plurality of pressure pulses. Optionally, stopping air flow out of the second port of the detector comprises at least one of closing a second valve positioned between the sample pump and the second port or stopping the sample pump. Optionally, the second predefined period of time ranges from one second to 60 seconds. Optionally, the second predefined period of time is based on at least one of a sample size or substance type.

Optionally, the method further comprises, after the second predefined period of time: measuring a residual presence of the one or more substances; determining an alarm condition based on a residual presence of the one or more substances; and repeatedly clearing the detector based on the determined alarm condition. Optionally, the method further comprises preparing the detector for further sampling if the alarm condition indicates the residual presence of the one or more substances below a predefined threshold. Optionally, the method further comprises performing a clearing of the detector after a predetermined amount of operating time of the trace detector is completed.

The present specification also discloses a trace detection system adapted to detect a presence of one or more substances, the system comprising: a housing; a first pump positioned in the housing and configured to direct air from outside the housing; a detector positioned in the housing, wherein the detector comprises a first port configured to receive a sample gas flow and a second port in flow communication with the first pump; a second pump positioned in the housing, wherein the second pump is in flow communication with the first port and is configured to generate the sample gas flow; a desorber positioned in the housing and in flow communication with the first pump; a first valve positioned between the desorber and the first pump; and a controller configured to: operate the trace detection system in a first mode for a first period of time wherein in the first mode: the first pump is configured to direct air flow through the first valve to an inlet of the desorber and direct air flow through the second port of the detector; the second pump is configured to direct air flow from the first port of the detector; the desorber is configured to vaporize the one or more substances; the detector is configured to detect a presence of the one or more substances and, in response to detecting the presence of the one or more substances, generate an alarm and terminate the first mode prior to the first predefined period of time elapsing; operate the trace detection system in a second mode wherein in the second mode: the detector is configured to be cleared for a second predefined period of time by stopping air flow out of the first port of the detector, closing the first valve to stop air flow from the first pump to the inlet of the desorber, and increasing air flow from the first pump to the second port of the detector.

Optionally, after the second predefined period of time, the controller is configured to open the first valve and re-direct air flow through the first valve to the inlet of the desorber, thereby re-initiating air flow out of the first port of the detector. Optionally, the system further comprises, using the second pump, generating a plurality of pressure pulses. Optionally, the controller is configured to stop air flow out of the first port of the detector by closing a second valve positioned between the second pump and the first port or stopping the second pump.

Optionally, the second predefined period of time ranges from one second to 60 seconds.

Optionally, the second predefined period of time is based on at least one of a sample size or substance type. Optionally, after the second predefined period of time, the controller is configured to: measure a residual presence of the one or more substances; determine an alarm condition based on a residual presence of the one or more substances; and repeat clearing the detector based on the determined alarm condition.

Optionally, the controller is configured to prepare the detector for further sampling if the alarm condition indicates the residual presence of the one or more substances below a predefined threshold. Optionally, the controller is configured to operate the trace detection system in the second mode after a predetermined amount of operating the trace detector is completed.

The present specification also discloses a trace detection system adapted to detect a presence of one or more substances, comprising: a housing; a first pump positioned in the housing and configured to direct air from outside the apparatus; a detector positioned in the housing, wherein the detector comprises a first port configured to receive a sample gas flow and a second port in flow communication with the first pump; a second pump positioned in the housing, wherein the second pump is in flow communication with the first port and is configured to generate the sample gas flow; a desorber positioned in the housing and in flow communication with the first pump; a first valve positioned between the desorber and the first pump; a purge pump positioned in the housing and configured to direct air from outside the apparatus, wherein the air flows from the purge pump towards the desorber through the detector; and a controller configured to: operate the trace detection system in a first mode wherein in the first mode: the first pump is configured to direct air flow through the first valve to an inlet of the desorber and direct air flow through the second port of the detector; the second pump is configured to direct air flow from the first port of the detector; the desorber is configured to vaporize the one or more substances; the detector is configured to detect a presence of the one or more substances and, in response to detecting the presence of the one or more substances, generate an alarm; operate the trace detection system in a purge mode wherein in the purge mode: the detector is configured to be cleared for a predefined period of time by stopping air flow out of the first port of the detector, closing the first valve to stop air flow from the first pump to the inlet of the desorber, and increasing air flow from the purge pump to the second port of the detector.

Optionally, the detector is at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a traveling wave ion mobility spectrometer, a mass spectrometer (MS), or a gas chromatograph (GC). Optionally, the one or more substances comprise contaminants or interferants. Optionally, the contaminants comprise one or more of TNT, RDX, Tetryl, nitrates, PETN, HMTD, lactic acid, interferences, or narcotics. Optionally, the interferents comprise at least one of a health product, a beauty product, food, drink, dirt, dust, oil, or grease.

Optionally, after the predefined period of time, the controller is configured to: measure a residual presence of the one or more substances; determine an alarm condition based on the residual presence of the one or more substances; and repeat clearing the detector based on the determined alarm condition. Optionally, the controller is configured to cause the residual amount of the one or more substances in the detector to become less than a configurable amount, wherein the configurable amount ranges from 60 to 80% of detectable signal intensity required to generate an alarm.

The aforementioned and other embodiments of the present specification shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1A shows a simplified pneumatic schematic of an ETD, in accordance with an embodiment of the present specification;

FIG. 1B shows a simplified pneumatic schematic of an ETD, in accordance with another embodiment of the present specification;

FIG. 2 is a graphical representation of signals received from two differential pressure transducers (DPTs) and the sample pump plotted voltage (V) versus time (seconds), in accordance with an implementation of the present specification;

FIG. 3 is a flow chart illustrating an exemplary process of clearing an ETD, in accordance with embodiments of the present specification;

FIG. 4A is a table illustrating a comparison of clear down effectiveness; and

FIG. 4B is a graph illustrating a comparison of clear-down effectiveness with air triggers.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present specification is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present specification.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

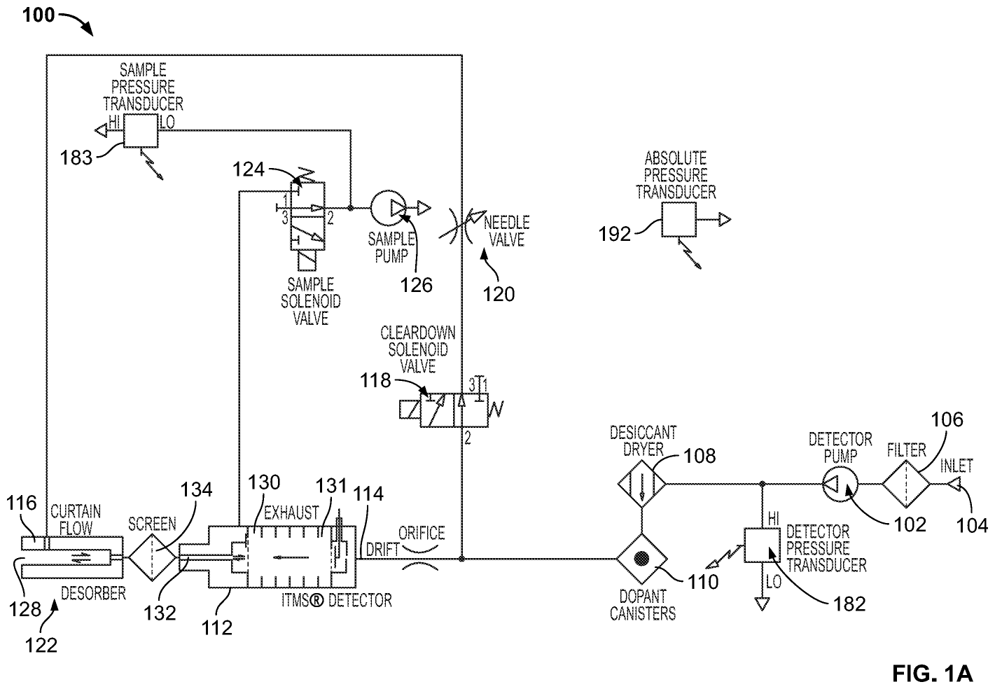

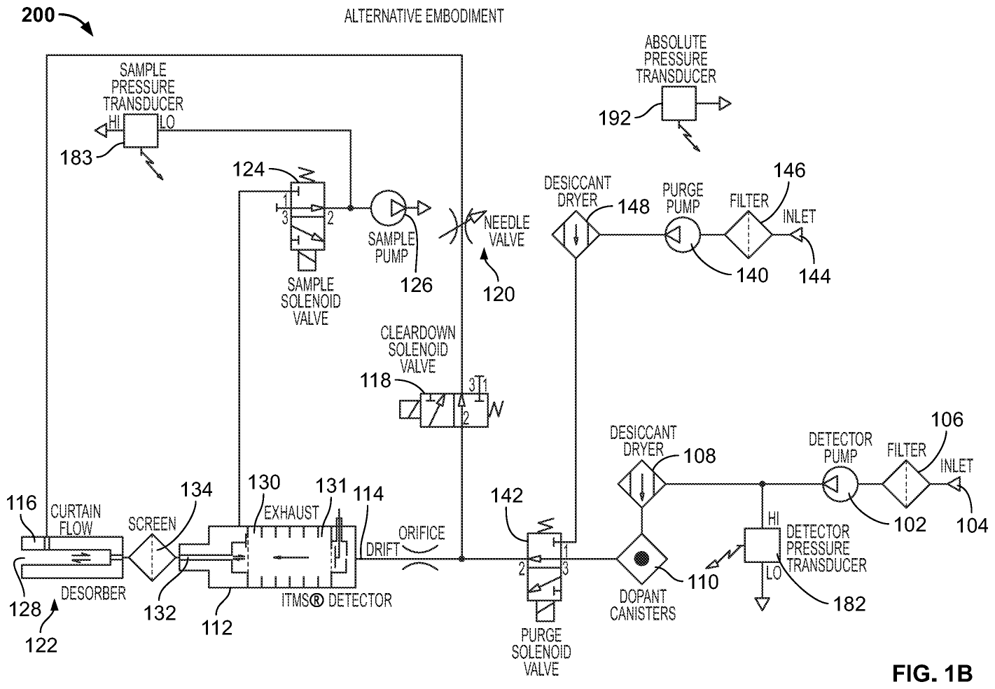

FIG. 1A depicts a simplified pneumatic schematic of an ETD 100, in accordance with some embodiments of the present specification. During sampling, an ionization source is used to ionize one or more substances (e.g., a sample, calibrant, verification substance, and/or sensitivity substance) within a detector 112. The ionization source may be any ionization system that enables operation of the methods and systems as described herein, including, without limitation, at least one of: a radioactive ionization source, an electrospray ionization source (ESI), an atmospheric pressure chemical ionization (APCI) source, a corona discharge ionization source, a partial discharge ionization source, an atmospheric pressure photoionization (APPI) source, an atmospheric pressure glow discharge (APGD) source, a direct analysis in real-time (DART) source, an atmospheric pressure dielectric barrier discharge (APDBD) source, and an electron ionizer (EI). In some embodiments of the present disclosure, the ionization source comprises at least one of an APCI source, an APPI source, an ESI source or a DART source. Some embodiments of the present disclosure are configured to operate at sub-atmospheric pressures. Such embodiments include an ionization source that is, without limitation, a chemical ionization (CI) source, a photoionization (PI) source, a glow discharge (GD) source, a dielectric barrier discharge (DBD) source and combinations thereof.

In some embodiments, detector 112 of the present disclosure (also referred to herein as an “analysis device”) includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a mass spectrometer (MS), a gas chromatograph (GC), and combinations thereof.

Detector 112 is configured to detect and identify constituents in a sample input thereto. For example, in some embodiments, detector 112 is configured to detect one or more substances of interest in a sample gas, such as one or more volatile or non-volatile substances of interest. Detector 112 includes a detector inlet 132 through which substances enter detector 112. In an embodiment, system 100 comprises an absolute pressure sensor 192 for monitoring the pressure of the system.

A sample pump 126 is in flow communication with detector 112 via a sample valve 124. In the illustrated embodiment, valve 124 includes a three-way valve, such that, based on a position of valve 124, gas either does or does not flow through valve 124. Upon activation, sample pump 126 creates a vacuum which pulls gas from detector 112 through valve 124.

In embodiments, system 100 further includes a controller that is in data communication with each of the detector 112, pumps 126, 102, valves 120, 118, 124, pressure sensors 192, 182, 183, and other components, and is configured to receive data and transmit control data to each of the aforementioned components. In some embodiments, the controller may be located remote from system 100. In some other embodiments, the controller is integral to system 100. In some embodiments, the controller includes a memory device and a processor operatively coupled to the memory device for executing instructions. In some embodiments, executable instructions are stored in the memory device. The controller is configurable to perform one or more operations described herein by the programming processor. For example, in some embodiments, the processor is programmed by encoding an operation as one or more executable instructions and providing the executable instructions in the memory device. In the exemplary embodiment, the memory device is one or more devices that enable storage and retrieval of information such as executable instructions and/or other data. The memory device includes one or more computer readable media in some embodiments.

The memory device is configured to store a pre-programmed library of mobility spectra, each mobility spectrum associated with one substance of a plurality of substances. Memory device may further store associated drift times, alarm limits, detection history, calibration profiles and history (e.g., verification history) for detector 112 in system 100, and/or any other type of data in some embodiments. In the exemplary embodiment, the controller, including the memory device, includes, without limitation, sufficient computer-readable/executable instructions, sufficient data and data structures, algorithms, and commands to facilitate detection of substance(s) introduced into detector 112 (e.g., a sample, the calibrant, the verification substance, and/or the sensitivity substance).

In the exemplary embodiment, system 100 further includes an operator presentation and/or control interface coupled to the controller. The interface presents data, such as mobility spectra, calibration procedures, verification outcomes, and/or sensitivity check outcomes. In some embodiments, the interface includes one or more display devices. In some embodiments, the interface presents an audible and/or graphical notification upon detection of a substance of interest. Also, in some embodiments, the interface facilitates control of the controller and manual data input into the computing device. Furthermore, in some embodiments, the controller is coupled in communication with one or more other devices, such as another computing device, locally or remotely. As such, in some embodiments, system 100 is networked with other systems and devices such that data transmitted across portions of system 100 is accessed by any device capable of accessing the controller including, without limitation, desktop computers, laptop computers, and personal digital assistants (PDAs) (neither shown).

As used herein, the term “controller”, “computer”, “computing device” and related terms are not limited to integrated circuits referred to in the art as a computer, but broadly refers to a microcontroller, a microcomputer, a programmable logic controller (PLC), an application specific integrated circuit, and other programmable circuits, and these terms are used interchangeably herein. Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Embodiments of the present specification provide methods and systems for reducing a clear-down time in Electronic Trace Detectors (ETDs). Upon following a detection alarm, in accordance with the embodiments of the present specification, the ETD performs a cleaning protocol to clear the flow path in preparation of the next sample. Accordingly, upon detection of an alarm, the ETD is stopped by shutting off a sample pump and closing a valve to a curtain flow, which is a flow of air inputted into the sample inlet and configured to cause sample particles to flow toward the detection device. Drift flow, which is the flow of air through the drift chamber 131 of the detector 112, directionally moves from the detector port 114 toward the drift inlet 132. During clear-down, the drift flow and detector pressure are increased driving air flow through the ETD to remove contaminants. Subsequently, the sample pump 126 is pulsed at a rate of 1 to 5 pulses, preferably 3, in less than 20 seconds, preferably 6 seconds, to rapidly stabilize the pressure in the ETD during the clear-down, where each pulse comprises turning on the pump for a period of 1-4 seconds or any increment therein. In an embodiment, the configurable elements of a pressure pulse are: sample pump on time (0.001 to 30 seconds), sample pump off time (0 to 30 seconds), number of cycles (1 to 50), and pressure amplitude (0.1 to 10 inches of water).

Stopping detection operation of the ETD on an alarm detection ensures that the amount of sample in the ETD is reduced, which, in turn, reduces the length of the clear-down operation. Embodiments of the procedure in accordance with the present specification provide a consistent baseline in ETDs for their precise and accurate operation. More specifically, that baseline provides for an amount of residual substances of interest in the ETDs being less than a configurable amount which typically ranges from 60 to 80% of the signal intensity required to generate an alarm.

For the purpose of describing this invention, three instrument modes, a first mode, a second mode, and a third mode, are discussed. The three modes include an idle mode, a sample mode, and a clear-down mode. A detector pump 102 pulls air through an air inlet 104 and a filter 106 during each of the three modes. The flow of air progresses through a dryer 108, configured to remove moisture from the air flow being provided by the detector pump 102, and a dopant source 110, configured to provide a source of dopants into the air flow being provided by the detector pump 102. A pressure sensor 182 is in flow communication with the detector 112 and provides a measure of the pressure level in the flow path from the detector 112 to the inlet 104.

During idle mode, when the ETD is not in active detection or clear-down, the flow of air splits into two paths. A portion of the air flow forms the drift flow by entering the detector 112 at a drift port 114. The remainder of the flow forms a curtain flow 116, passing through a clear-down valve 118 and needle valve 120, which are deactivated, and entering desorber 122 where it may exit an inlet 128 of desorber 122 or pass toward the screen 134. The flow rate is controlled using an orifice and needle valve 120. In the idle mode, solenoid valves 124 (also termed as sample valve 124) are deactivated, and a sample pump 126 is off.

During the sample mode, when the clear-down valve 118 and needle valves 120 are open to allow the increased flow of air from inlet 104 to desorber 122, a swab or trap with a substance of interest is inserted into front opening 128 of desorber 122. Either manually or upon detection of a swab in desorber 122, sample valve 124 is activated, and sample pump 126 is turned on. Pressure sensor 183 monitors the pressure level in the sample pump air path. Air is pulled into the sample pump air path through desorber 122 into detector 112. This also draws any gas containing the sample desorbed from the swab into detector 112 where it is analyzed. The air flow exits detector 112 through an exhaust port 130. ETD 100 alarms if detector 112 recognizes a substance of interest such as an explosive or narcotic.

While conventional systems use a standardized sampling time, after which a clear down mode may be initiated, the presently disclosed methods and systems preferably initiate a clear down mode immediately upon detecting a substance of interest. Therefore, in one embodiment, the system implements a standardized sampling time of a predefined period of time, programmed into the controller which is configured to control the pumps, detector and valves, wherein the standardized sampling process is terminated before the predefined period of time elapses if the detector recognizes a substance of interest and communicates data indicative of that identification to the controller. This has the substantial benefit of 1) decreasing sampling time and thereby increasing throughput and 2) minimizing the amount of substance that has to be cleared from the system, thereby minimizing clear-down times.

In one embodiment, clear-down mode is activated automatically upon detection. In another embodiment, the system stops detection and provides a visual or auditory signal to the operator to manually initiate clear-down mode. During the clear-down mode, sample pump 126 is shut off, and sample valve 124 is closed to air flow from exhaust 130 to sample pump 126. After between 1 and 30 seconds, preferably less than 10 seconds, clear-down valve 118 is activated, which closes the valve 118 and eliminates or stops the resulting curtain flow 116. Air now only flows from inlet 104, through dryer 108 and dopants 110 to port 114. The flow that was previously used for curtain flow 116 now enters the detector through drift port 114 and leaves detector 112 through desorber 122. The increased drift flow purges contaminants from detector 112 and desorber 122. Note that the increased drift flow purge is achieved 1) without requiring a separate, or additional, clear-down pump, and uses the same detector pump 102 that provides the drift and curtain flow and 2) does not require modulating the operation of the detector pump 102, which can remain on throughout the idle, sampling, and clear-down modes. In an embodiment the detector pump 102 is driven to a maximum power during clear-down mode for providing a maximum drift flow and pressure in the ETD.

The amount of time for which the purging is enabled may vary. In some embodiments, the purging is performed for a time in the range of 1 to 60 seconds. In one embodiment, the purging is performed for about 20 to 30 seconds or, more preferably, 25 seconds. After a predefined amount of purging time, clear-down valve 118 is deactivated, or opened, allowing the flow to split between drift port 114 and curtain at 116, again. At this point ETD 100 is in a state of unbalanced internal pressure. It should be appreciated that conventional systems do not actively stabilize the unbalanced internal pressure before conducting another sampling process, which often results in inaccurate time of flight readings and negatively effects the accuracy and precision of the system. Alternatively, a conventional system may simply wait for the internal pressure to balance itself, but that adds time to the clear-down process.

Preferably, the unbalanced internal pressure would be actively, and quickly, corrected so that 1) clear-down times are not unnecessarily lengthened and 2) the internal pressure is balanced upon a subsequent sampling process. Accordingly, in one embodiment, the controller is configured to activate sample pump 126 to run a series of short pulses to stabilize the pressure and bring ETD 100 back to its baseline. For example, the short pulses comprise turning on the sample pump 126 for a short period, such as for less than 10 seconds, preferably less than 5 seconds, preferably in a range of 1 to 5 seconds, and then shutting it off to create a “pulse”. In one embodiment, a series of 1 to 10 of these pulses, preferably less than 5, are sequentially conducted. In one embodiment, the controller is configured to receive pressure data from a pressure sensor in communication with the detector, such as detector pressure 182, and, based on the pressure data, to activate the sample pump for a period of time or a number of pulses required to bring the pressure back to a balanced state. In another embodiment, the controller is configured to automatically activate the sample pump for a predefined period of time or a predefined number of pulses that, on average, is required to bring the pressure back to a balanced state without relying on actual real-time pressure readings. In an embodiment, the sample pump 126 runs three short pulses, of 1 to 2 seconds each, as determined by using a feedback loop between the detector pressure sensor 182 and the sample pump 126.

Following the stabilizing of the pressure within detector 112, ETD 100 performs a sampling of air and analyzing the gas to ensure that its system is clear. If no additional alarms are detected, ETD 100 returns to idle mode. Alternatively, if an alarm is detected, the clear-down mode is repeated. If a high concentration or mass of a substance is introduced into ETD 100, the clear-down process may continue for an extended time. In embodiments, the clear-down time varies in a range of 1-5 minutes, depending on an amount and type of the substance introduced into the ETD100.

FIG. 1B shows a simplified pneumatic schematic of an ETD, in accordance with another embodiment of the present specification. All elements of FIG. 1B are the same as FIG. 1A, except with the following modifications. As shown in FIG. 1B ETD 200 is equipped with a purge pump 140 and a purge valve 142. During a clear-down mode, when the sample pump 126 is shut off, and sample valve 124 is closed to air flow from exhaust 130 to sample pump 126, valves 142 and 118 are activated, which eliminate or stops the resulting curtain flow 116. Air now only flows from inlet 144, through filter 146, through desiccant dryer 148 and to port 114. The flow that was previously used for curtain flow 116 now enters the detector through drift port 114 and leaves detector 112 through desorber 122. The increased drift flow purges contaminants from detector 112 and desorber 122.

Embodiments of the present specification provide methods that offer operators of ETDs the flexibility to decide which alarm conditions should activate the clear-down mode. Since some alarming substances can clear rapidly on their own, in some cases the clear-down mode may not be required or may be required for very little time, thereby avoiding unnecessary delay in sampling. In an embodiment, the clear-down mode is activated only in situations when excessive time to clear is predicted to complete, or a contaminant is believed to be present. In order to determine the presence of contamination, embodiments of the present specification monitor dopant peak heights in both negative and positive polarities as well as the presence of contaminant peaks. In embodiments, the polarities are switched to attract both positive and negative ions in the same detector. Clear-down mode may be activated both if the dopant level is consumed by a sample and its peak height drops below the assigned threshold and/or if any of the recorded peak heights surpass the threshold in the detector 112. The detector 112 lists the details of specific compounds (or lines) including peak drift times and heights which were determined empirically. All lines in the detector 112 are interconnected with “OR” logic. So, when one or multiple contamination lines trigger an alarm—clear-down mode is activated. The list of contaminants includes but is not limited to: TNT, RDX, Tetryl, nitrates, PETN, HMTD, lactic acid, interferences, and narcotics. Interferents can include but are not limited to: health and beauty products, food and drink, dirt, dust, oil, and greases. While this list includes most of the common compounds which are difficult to clear, persons skilled in the art may appreciate that this list is not exhaustive and may include other types of substances of interest.

In some embodiments of operation of ETD 100, in accordance with the present specification, the clear-down operation is performed each time either after sample pump 126 is deactivated or before it is activated and/or where pump 126 is activated for a predetermined amount of time. This may be referred to as ‘normal sampling’.

In some other embodiments of operation of ETD 100, in accordance with the present specification, the clear-down operation is performed when ETD 100 deactivates pump 126 prior to the predetermined amount of time, as a result of analyzing the data in real time and determining that ETD 100 has enough sample to generate an alarm prior to the predetermined time of a normal sample. In an embodiment, the predefined time of deactivation of the pump is smaller than an operator's shift period, which may range from 1 to 1440 minutes. This method may be referred to as ‘Stop on Detect’, since sample pump 126 is stopped as soon as an alarm condition is detected. ‘Stop on Detect’ ensures that ETD 100 does not intake more sample than is necessary so that detection performance can be maintained while reducing the clear-down time after an alarm. Testing has shown a larger sample tends to take longer to clear. Therefore, by minimizing the sample using ‘Stop on Detect’, the clear-down time is reduced.

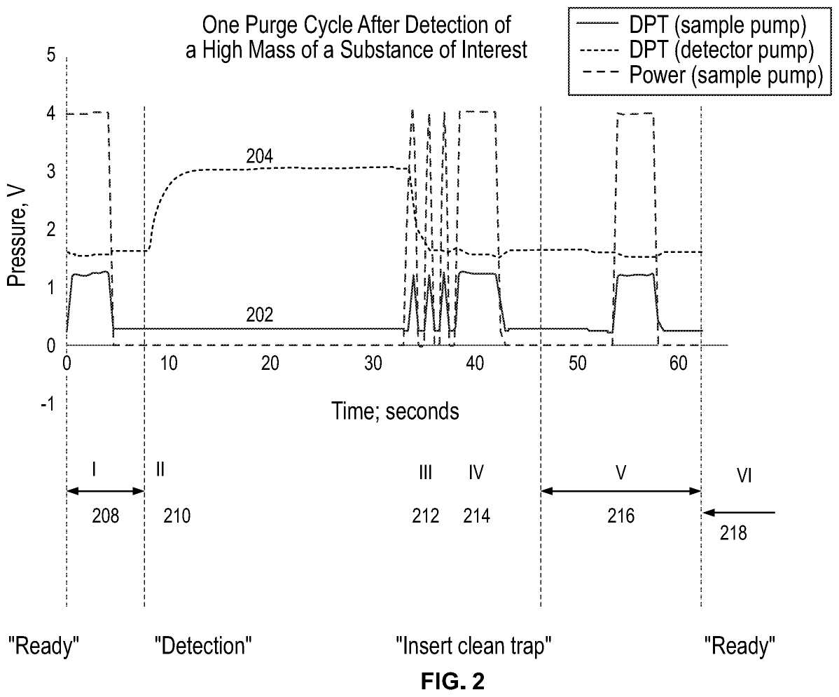

FIG. 2 is a graphical representation of signals received from two differential pressure transducers (DPTs) and the sample pump plotted voltage (V) versus time (seconds), in accordance with an implementation of the present specification. Referring simultaneously to FIGS. 1 and 2, line 202 represents the voltage measured at pressure transducer 183, line 204 represents the voltage measured at pressure transducer 182, and line 206 represents the power measured at sample pump 126. The measurements are broadly divided in different regions relative to time, where a first region 208 (region I) initiates from the time from when ETD 100 is ready for sampling. At time t=0, a trap or swab is inserted into desorber 122 to initiate the sample mode. In an embodiment, where power supply to sample pump 126 is cut after 4 seconds, a user is informed of the same at t=8. Second region 210 (region II) initiates at time t=8, when ETD 100 alarms and prompts the user to activate the clear-down mode.

From t=8, line 204 is seen to rise as back pressure rises at detector pump 102 after activating clear-down valve 118 as all the flow is forced into the detector 112 at port 114. After about t=33 seconds, clear-down valve 118 is deactivated and pressure is unbalanced. Sample pump 126 pulses three times in region 212 (region III) and then performs an air trigger in region 214 (region IV) to bring the pressure into equilibrium. In various embodiments, equilibrium is defined as the detector pressure being the same as in idle mode. ETD 100 performs an air sample to check if the clear-down was successful in region 216 (region V) by determining if any residual substances of interest remain in the detector 112 above a threshold amount. If ETD 100 recognizes that the system has a level of contamination below a predefined threshold, it will direct the operator to insert a clean trap for a final check in region 218 (region VI). If either regions 216 or 218 show signs of high contamination, ETD 100 will go back to region 210 and repeat the entire clear-down process. If, however, regions 216 or 218 show only minor contamination, ETD 100 will cycle through steps 216 and 218 only until the system is clear.

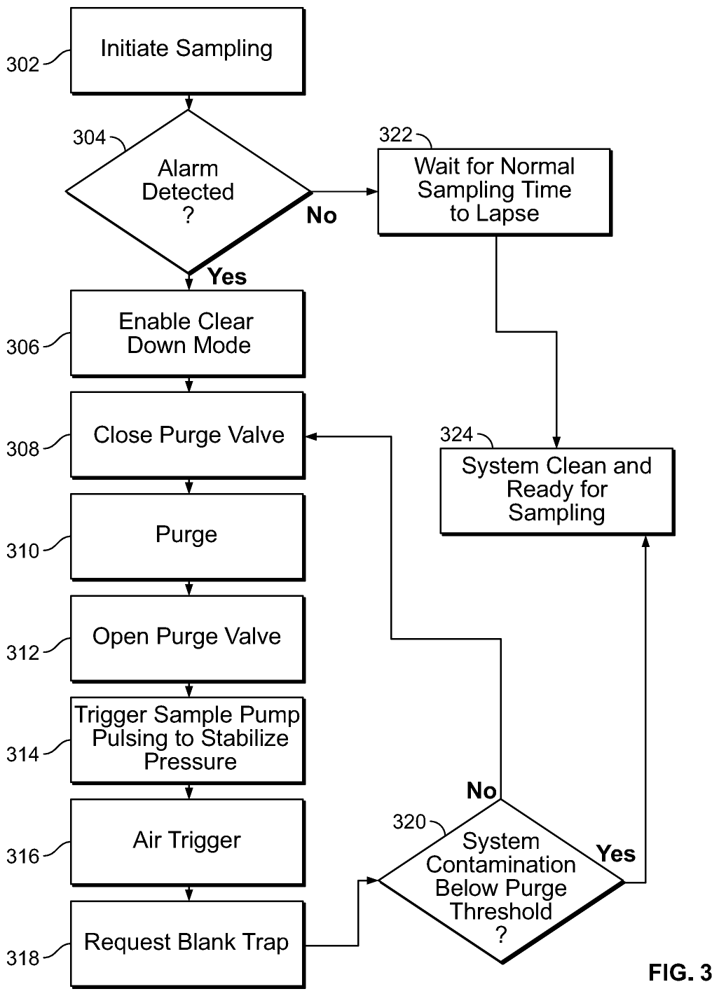

FIG. 3 is a flow chart illustrating an exemplary process of clearing an ETD, in accordance with embodiments of the present specification. Referring simultaneously to FIGS. 1 and 3, at 302, a trap or swab is inserted into desorber 122 to initiate sampling. A swab or trap with a substance of interest is inserted into front opening 128 of desorber 122. Upon detection of a swab in desorber 122, sample valve 124 is activated, or opened, and sample pump 126 is turned on. Extra air is pulled in through desorber 122 into detector 112. This also draws any vaporized samples desorbed from the swab into detector 112 where it is analyzed. The flow exits detector 112 through an exhaust port 130.

At 304, an alarm condition is detected by EDT 100, when a substance of interest such as an explosive or narcotic is identified by detector 112. At 306, the clear-down mode is enabled either manually or automatically upon detection, cutting short a predefined sampling period which, as shown in 322, would have otherwise proceeded. In the clear-down mode, sample pump 126 is stopped and sample valve 124 is closed. After a few seconds, at 308, clear-down valve 118, also referred to as a purge valve 142 in FIG. 1B, is closed, thereby eliminating curtain flow 116. At 310, flow of air is forced from inlet 104 through drift port 114, and into detector 112. Air flow that was previously used for curtain flow 116 now enters detector 112 through drift port 114 and leaves detector 112 through desorber 122. The increased drift flow purges contaminants from detector 112 and desorber 122, as exemplified by step 310. The amount of time for which the air purges through detector 112 may vary in the range of 1 to 60 seconds. In some cases, the purging is performed for a time more than 60 seconds.

After some time, at 312, clear-down valve 118 is opened, thereby allowing the flow to split again between drift flow at port 114 and curtain flow 116. At this stage, detector 112 is in a state of unbalanced pressure. Therefore, at 314, sample pump 126 is enabled to pump consecutively for a few times with a series of short pulses in order to bring the pressure into equilibrium. At 316, an air trigger is performed which initiates an exhaust or sample flow from the detector and a blank trap is requested 318.

At 320, the system samples and analyzes air to determine if the system is sufficiently at a baseline reading, also referred to as a purge threshold. If yes, then at 324, system 100 is returns to idle mode and is ready for sampling. If not, the ETD 100 returns to a clear-down mode, steps 308-318, by closing the clear down valve and continuing to purge bypassing all air flow from the detector pump through the detector (eliminating curtain flow and sample flow). The process repeats until air within detector 112 is confirmed to be successful, i.e. when the level of contaminants is determined to be below a threshold. If there are still signs of high contamination, ETD 100 returns to the clear-down mode and repeats the entire clear-down process.

In embodiments, ETD 100 continues sampling at 322 for a predetermined amount of time, in the event that an alarm condition is not detected. In an embodiment, ETD 100 continues sampling at 322 for 8 seconds. The clear-down mode is enabled at 308, after region 210 of the sample scheme in FIG. 2 is completed.

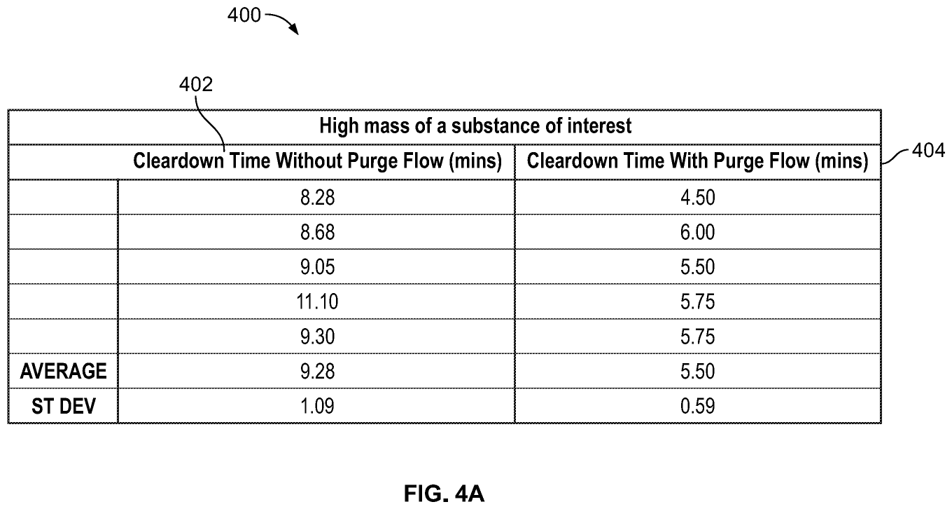

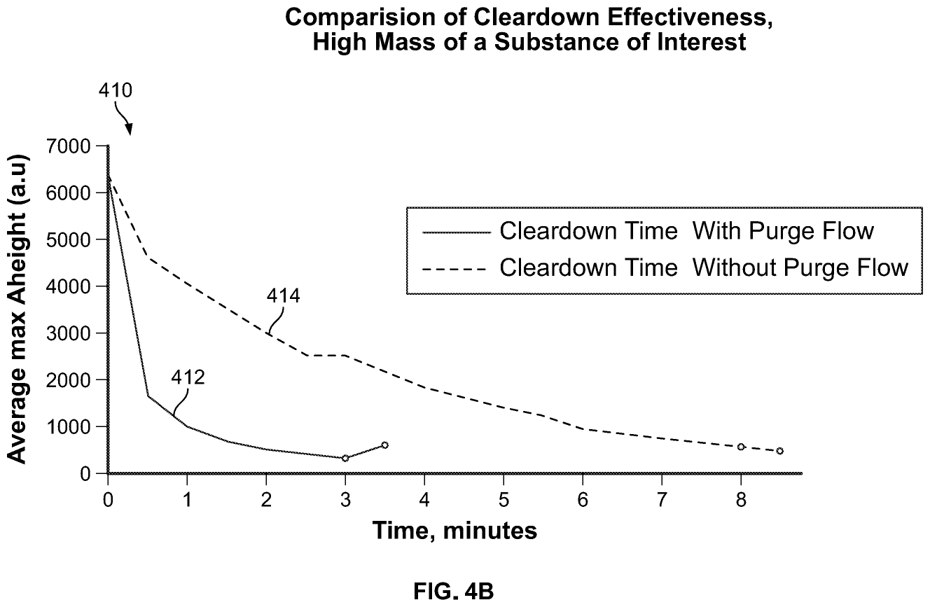

In various embodiments, in clear-down mode, when the clear down valve and thereby the curtain flow is closed, air flows swiftly through the detector through the drift port and the increased drift flow purges contaminants from the detector and desorber. Hence, in embodiments, by shutting off air flow in other parts of the circuit shown in FIGS. 1A and 1B, clear-down time is decreased, due to the drift/purge flow. FIG. 4A is a table illustrating a comparison between clear-down times in the ETD system with and without purge flow, in accordance with an embodiment of the present specification. Table 400 comprises a column 402 showing clear-down times (in minutes) of an EDT system that does not comprise purge flow for clearing contaminants from the detector of the system; and a column 404 showing corresponding clear-down times (in minutes) of the same EDT system with purge flow for clearing contaminants. As can be seen from table 400, when comparing different high masses of a substance of interest, with the introduction of purge flow, clear-down time decreases from 8.28 minutes to 4.50 minutes; from 8.68 minutes to 6.00 minutes; from 9.05 minutes to 5.50 minutes; from 11.10 minutes to 5.75 minutes; and, from 9.30 minutes to 5.75 minutes. The average reduction of clear-down time with the introduction of purge flow is from 9.28 minutes to 5.50 minutes, with a standard deviation of 1.09 minutes and 0.59 minutes, respectively.

In various embodiments the increased drift flow purge is achieved without using separate or additional clear-down pumps. The same pump that is used to provide the curtain flow is also used to provide the drift/purge flow by shutting down air flow in other parts of the circuit. Further, for increasing the drift flow for purging the detector faster, there is no requirement of modulating the operation of the pump, which remains operational throughout the idle, sampling, and clear-down modes. Hence, at least in one embodiment, (such as shown in FIG. 1A), without modulating (shutting off or turning on) the detector pump, the system of the present specification is able to transition from a first state having curtain flow greater than drift flow to a second state where the drift flow (the purge stream) increases by nearly 100% (in the range of 50-150%). In the embodiment of the system shown in FIG. 1B, said increase in drift flow is achieved by activating the purge pump and purge valve to eliminate curtain flow.

In various embodiments, during idle mode, when the ETD is not in active detection or clear-down, the flow of air is split into two paths as described above. A portion of the air flow forms the drift flow by entering the detector at the drift port; while the remainder of the flow forms the curtain flow, passing through the clear-down valve which is deactivated (open), and entering the desorber. Hence, in the idle mode, since the sample pump is deactivated, the sample flow (or exhaust) is non-existent; the curtain flow is equal to or greater than the drift flow and the drift flow is equal to or less than the curtain flow.

During the sample mode, when the clear-down valve is open to allow the increased flow of air from the air inlet to the desorber, and a swab with a substance of interest is inserted into front opening of the desorber; upon detection of the swab, the sample valve is activated, and sample pump is turned on, causing air to be pulled into the sample pump air path through into detector. This also draws any gas containing the sample desorbed from the swab into the detector where it is analyzed. In the sample mode, drift/purge flow is very little as compared to the sample flow and even the curtain flow, since the clear-down valve is in an open state and sample pump is active. Hence, in sample mode, curtain flow is equal to or greater than drift flow, drift flow is equal to or less than curtain flow, and sample flow is greater than either curtain flow or drift flow.

In various embodiments, during clear-down mode, since the clear-down valve is closed curtain flow is stopped, and air only flows from the inlet, through dryer and dopants and enters the detector through the drift port for purging said detector and leaves via the desorber. Hence, during clear-down mode curtain flow and sample/exhaust flow are 0 cc/min while the drift flow increases by 50-150%. as compared to during the idle and sample modes.

For example, during operation in an ETD according to the present specification, in the idle mode the curtain flow is approximately 125 cc/min+/−50%, the drift flow is approximately 100 cc/min+/−50% while the sample flow is 0 cc/min. In the sample mode the curtain flow is approximately 100 cc/min+/−50%, the drift flow is approximately 75 cc/min+/−50% and the sample flow is greater than both curtain and drift flow being at 180 cc/min+/−50%. However, in the clear-down mode both curtain and drift flows are 0 cc/min, while the purge flow is approximately 192 cc/min+/−50%.

FIG. 4B is a graph illustrating a comparison of clear-down effectiveness with air triggers after a substance of high mass is detected in an ETD system, in accordance with an embodiment of the present specification. Graph 410 compares the clear-down times of an ETD when a substance of interest having a high mass is detected. Plot 412 and 414 depict the clear-down times with and without a purge flow, respectively. As has been explained above, the clear-down time without a purge flow in an ETD system is much greater than that with the purge flow. As shown in FIG. 4B the maximum clear-down time without a purge flow ranges from 8 to 9 minutes while that with the purge flow ranges from 3 to 4 minutes.

Although specific features of various embodiments of the disclosure may be shown in some drawings and not in others, this is for convenience only. In accordance with the principles of the disclosure, any feature of a drawing may be referenced and/or claimed in combination with any feature of any other drawing. The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A method for clearing a trace detector of one or more substances, wherein the trace detector comprises a desorber in flow communication with a detector and wherein the detector comprises a detector input, a first port, and a second port, the method comprising:
operating a detector pump, wherein the detector pump is configured to direct air flow through a first valve to an inlet of the desorber and direct air flow through the first port to the detector;
operating a sample pump, wherein the sample pump is configured to direct air flow from the second port of the detector;
using the desorber, vaporizing the one or more substances;
using the detector, initiating a detection process for a first predefined time period in order to detect a presence of the one or more substances;
in response to detecting the presence of the one or more substances, generating an alarm indicating the presence of at least one contaminant or interferant;
in response to detecting the presence of the one or more substances, automatically terminating detection before the first predefined period of time has elapsed;
after terminating detection, clearing the detector, wherein clearing the detector comprises, for a second predefined period of time:
stopping air flow out of the second port of the detector;
closing the first valve to stop air flow from the detector pump to the inlet of the desorber; and
increasing air flow from the detector pump to the first port to the detector.

2. The method of claim 1, further comprising causing an amount of the contaminants or the interferants in the trace detector to become less than a configurable amount, wherein the configurable amount ranges from 60 to 80% of a detectable signal intensity required to generate an alarm.

3. The method of claim 1 further comprising, after the second predefined period of time, opening the first valve and re-directing air flow through the first valve to the inlet of the desorber, thereby re-initiating air flow out of the second port of the detector.

4. The method of claim 1, wherein the detector pump is driven at a maximum voltage corresponding to a maximum flow rate and pressure of the detector.

5. The method of claim 1, wherein the contaminants comprise one or more of TNT, RDX, Tetryl, nitrates, PETN, HMTD, lactic acid, interferences, or narcotics.

6. The method of claim 1 wherein the detector is at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a traveling wave ion mobility spectrometer, a mass spectrometer (MS), or a gas chromatograph (GC).

7. The method of claim 1 wherein the interferents comprise at least one of a health product, a beauty product, food, drink, dirt, dust, oil, or grease.

8. The method of claim 1 further comprising, using the sample pump, generating one or a plurality of pressure pulses.

9. The method of claim 1 wherein stopping air flow out of the second port of the detector comprises at least one of closing a second valve positioned between the sample pump and the second port or stopping the sample pump.

10. The method of claim 1 wherein the second predefined period of time ranges from one second to 60 seconds.

11. The method of claim 1 wherein the second predefined period of time is based on at least one of a sample size or substance type.

12. The method of claim 1 further comprising, after the second predefined period of time:
measuring a residual presence of the one or more substances;
determining an alarm condition based on a residual presence of the one or more substances; and
repeatedly clearing the detector based on the determined alarm condition.

13. The method of claim 12 further comprising preparing the detector for further sampling if the alarm condition indicates the residual presence of the one or more substances below a predefined threshold.

14. The method of claim 1 further comprising performing a clearing of the detector after a predetermined amount of operating time of the trace detector is completed.

15. A trace detection system adapted to detect a presence of one or more substances, comprising:
a housing;
a first pump positioned in the housing and configured to direct air from outside the housing;
a detector positioned in the housing, wherein the detector comprises a first port configured to receive a sample gas flow and a second port in flow communication with the first pump;
a second pump positioned in the housing, wherein the second pump is in flow communication with the first port and is configured to generate the sample gas flow;
a desorber positioned in the housing and in flow communication with the first pump;
a first valve positioned between the desorber and the first pump; and
a controller configured to:
operate the trace detection system in a first mode for a first period of time wherein in the first mode:
the first pump is configured to direct air flow through the first valve to an inlet of the desorber and direct air flow through the second port of the detector;
the second pump is configured to direct air flow from the first port of the detector;
the desorber is configured to vaporize the one or more substances;
the detector is configured to detect a presence of the one or more substances and, in response to detecting the presence of the one or more substances, generate an alarm and terminate the first mode prior to the first predefined period of time elapsing;
operate the trace detection system in a second mode wherein in the second mode:
the detector is configured to be cleared for a second predefined period of time by stopping air flow out of the first port of the detector, closing the first valve to stop air flow from the first pump to the inlet of the desorber, and increasing air flow from the first pump to the second port of the detector.

16. The trace detection system of claim 15 wherein, after the second predefined period of time, the controller is configured to open the first valve and re-direct air flow through the first valve to the inlet of the desorber, thereby re-initiating air flow out of the first port of the detector.

17. The trace detection system of claim 15 further comprising, using the second pump, generating a plurality of pressure pulses.

18. The trace detection system of claim 15 wherein the controller is configured to stop air flow out of the first port of the detector by closing a second valve positioned between the second pump and the first port or stopping the second pump.

19. The trace detection system of claim 15 wherein the second predefined period of time ranges from one second to 60 seconds.

20. The trace detection system of claim 15 wherein the second predefined period of time is based on at least one of a sample size or substance type.

21. The trace detection system of claim 15 wherein, after the second predefined period of time, the controller is configured to:
measure a residual presence of the one or more substances;
determine an alarm condition based on a residual presence of the one or more substances; and
repeat clearing the detector based on the determined alarm condition.

22. The trace detection system of claim 21 wherein the controller is configured to prepare the detector for further sampling if the alarm condition indicates the residual presence of the one or more substances below a predefined threshold.

23. The trace detection system of claim 15 wherein the controller is configured to operate the trace detection system in the second mode after a predetermined amount of operating the trace detector is completed.

24. A trace detection system adapted to detect a presence of one or more substances, comprising:
a housing;
a first pump positioned in the housing and configured to direct air from outside the apparatus;
a detector positioned in the housing, wherein the detector comprises a first port configured to receive a sample gas flow and a second port in flow communication with the first pump;
a second pump positioned in the housing, wherein the second pump is in flow communication with the first port and is configured to generate the sample gas flow;
a desorber positioned in the housing and in flow communication with the first pump;
a first valve positioned between the desorber and the first pump;
a purge pump positioned in the housing and configured to direct air from outside the apparatus, wherein the air flows from the purge pump towards the desorber through the detector; and
a controller configured to:
operate the trace detection system in a first mode wherein in the first mode:
the first pump is configured to direct air flow through the first valve to an inlet of the desorber and direct air flow through the second port of the detector;
the second pump is configured to direct air flow from the first port of the detector;
the desorber is configured to vaporize the one or more substances;
the detector is configured to detect a presence of the one or more substances and, in response to detecting the presence of the one or more substances, generate an alarm;
operate the trace detection system in a purge mode wherein in the purge mode:
the detector is configured to be cleared for a predefined period of time by stopping air flow out of the first port of the detector, closing the first valve to stop air flow from the first pump to the inlet of the desorber, and increasing air flow from the purge pump to the second port of the detector.

25. The method of claim 24 wherein the detector is at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS), a differential mobility spectrometer (DMS), a traveling wave ion mobility spectrometer, a mass spectrometer (MS), or a gas chromatograph (GC).

26. The trace detector system of claim 24 wherein the one or more substances comprise contaminants or interferants.

27. The method of claim 26 wherein the contaminants comprise one or more of TNT, RDX, Tetryl, nitrates, PETN, HMTD, lactic acid, interferences, or narcotics.

28. The method of claim 26 wherein the interferents comprise at least one of a health product, a beauty product, food, drink, dirt, dust, oil, or grease.

29. The trace detection system of claim 24 wherein, after the predefined period of time, the controller is configured to:
measure a residual presence of the one or more substances;
determine an alarm condition based on the residual presence of the one or more substances; and
repeat clearing the detector based on the determined alarm condition.

30. The system of claim 29 wherein the controller is configured to cause the residual amount of the one or more substances in the detector to become less than a configurable amount, wherein the configurable amount ranges from 60 to 80% of detectable signal intensity required to generate an alarm.
